(19) United States
(12) Patent Application Publication
(10) Pub. No.: US 2024/0201665 A1
(43) Pub. Date: Jun. 20, 2024

(54) METHOD AND SYSTEM FOR AUTOMATICALLY CREATING A PLAN FOR HYBRID MANUFACTURING

(71) Applicant: Palo Alto Research Center Incorporated, Palo Alto, CA (US)

(72) Inventor: John T. Maxwell, III, Santa Clara, CA (US)

(73) Assignee: Palo Alto Research Center Incorporated, Palo Alto, CA (US)

(21) Appl. No.: 18/081,086

(22) Filed: Dec. 14, 2022

(51) Int. Cl. G05B 19/418

(52) U.S. Cl. CPC G05B 19/41835; G05B 2219/23012

(57) ABSTRACT

An approach to automating hybrid manufacturing is provided. This approach first splits an item of manufacture into irreducible pieces called atoms, then extracts constraints between the atoms, and then uses a planner to find the best way to assemble the atoms into the item of manufacture given the constraints. The approach splits the item into atoms based on various properties such as the presence or absence of support, the need for scaffolding, tool reachability constraints, and the presence of cycles of dependencies which prevent the item from being manufactured.

### BACKGROUND

Several relatively new types of manufacturing have emerged and are constantly evolving. For example, additive manufacturing builds up an item of manufacture layer by layer from nothing. Subtractive manufacturing starts with a block of material and removes material until the item of manufacturing is left. Hybrid manufacturing can start with nothing, build up part of the item of manufacture layer by layer, add some scaffolding, turn the item, build up more of the item, and then remove the scaffolding. Hybrid manufacturing could also start with a block of material, remove some material from one place and then add material elsewhere. Thus, hybrid manufacturing is a mixture of additive manufacturing and subtractive manufacturing. Automating hybrid manufacturing, like other forms of manufacturing, has challenges.

### BRIEF DESCRIPTION

According to one aspect of the presently described embodiments, a method comprises selecting a digital model for an item to be manufactured; iteratively splitting the model into atoms including selectively assigning for each atom at least one of an additive orientation and a subtractive orientation; extracting constraints between the atoms; determining how to assemble the atoms into the item to be manufactured based on the constraints; and, outputting information configured for realization or manufacturing of the item.

According to another aspect, the splitting is based on at least one of a presence or absence of support, a need for scaffolding, tool constraints, and a presence of cycles of dependencies.

According to another aspect, the splitting comprises initializing an agenda for the item.

According to another aspect, the agenda comprises search states and the splitting further comprises removing a search state from the agenda and processing the search state.

According to another aspect, the processing creates new search states added to the agenda.

According to another aspect, the splitting is completed when the agenda is empty.

According to another aspect, the splitting is informed by searching to determine a condition.

According to another aspect, the condition is orientation.

According to another aspect, the extracting comprises extracting at least one of support, clearance and connectedness constraints.

According to another aspect, the determining comprises determining whether there is an order of additive and subtractive actions that satisfies the constraints.

According to another aspect, the outputting comprises outputting to at least one of a three-dimensional printer or a system configured for additive, subtractive, or hybrid manufacturing.

According to another aspect of the presently described embodiments, a system for automated manufacturing comprises at least one processor; and, at least one memory having instructions stored thereon wherein execution of the instructions by the processor causes the system to: select a digital model for an item to be manufactured; iteratively split the model into atoms including selectively assigning for each atom at least one of an additive orientation and a subtractive orientation; extract constraints between the atoms; determine how to assemble the atoms into the item to be manufactured based on the constraints; and, output information configured for realization or manufacturing of the item.

According to another aspect, the model is split is based on at least one of a presence or absence of support, a need for scaffolding, tool constraints, and a presence of cycles of dependencies.

According to another aspect, the splitting comprises initializing an agenda for the item.

According to another aspect, the agenda comprises search states and the splitting further comprises removing a search state from the agenda and processing the search state.

According to another aspect, the processing creates new search states added to the agenda.

According to another aspect, the splitting is completed when the agenda is empty.

According to another aspect, the splitting is informed by searching to determine a condition.

According to another aspect, the condition is orientation.

According to another aspect, the constraints comprise at least one of support, clearance and connectedness constraints.

According to another aspect, the system determines whether there is an order of additive and subtractive actions that satisfies the constraints.

According to another aspect, the output information is sent to at least one of a three-dimensional printer or a system configured for additive, subtractive, or hybrid manufacturing.

### BRIEF DESCRIPTION OF THE DRAWINGS

FIG. 1 is an illustration describing the presently described embodiments;

FIG. 2 is an illustration describing the presently described embodiments;

FIG. 3 is an illustration describing the presently described embodiments;

FIG. 4 is an illustration describing the presently described embodiments;

FIG. 5 is an illustration describing the presently described embodiments;

FIG. 6 is an illustration describing the presently described embodiments;

FIG. 7 is an illustration describing the presently described embodiments;

FIG. 8 is an illustration describing the presently described embodiments;

FIG. 9(a) through FIG. 9(n) are a series of illustrations describing the presently described embodiments;

FIG. 10 is an illustration describing the presently described embodiments;

FIG. 11 is an illustration describing the presently described embodiments;

FIG. 12 is an illustration describing the presently described embodiments;

FIG. 13 is an illustration describing the presently described embodiments;

FIG. 14 is an illustration describing the presently described embodiments;

FIG. 15 is an illustration describing the presently described embodiments;

FIG. 16 is an illustration describing the presently described embodiments;

FIG. 17 is an illustration describing the presently described embodiments;

FIG. 18 is an illustration describing the presently described embodiments;

FIG. 19(a) through FIG. 19(m) are a series of illustrations describing the presently described embodiments;

FIG. 20 is an illustration describing the presently described embodiments;

FIG. 21 is an illustration describing the presently described embodiments;

FIG. 22 is an illustration describing the presently described embodiments;

FIG. 23 is an illustration describing the presently described embodiments;

FIGS. 24(a) through 24(d) are a series of illustrations describing the presently described embodiments;

FIGS. 25(a) and 25(b) are flowcharts of example methods according to the presently described embodiments; and,

FIG. 26 is a representative system diagram according to the presently described embodiments.

### DETAILED DESCRIPTION

According to the presently disclosed embodiments, one approach to automating hybrid manufacturing is to first split the item of manufacture into irreducible pieces called atoms herein, then extract constraints between the atoms, and then use a planner to find the best way to assemble the atoms into the item of manufacture given the constraints.

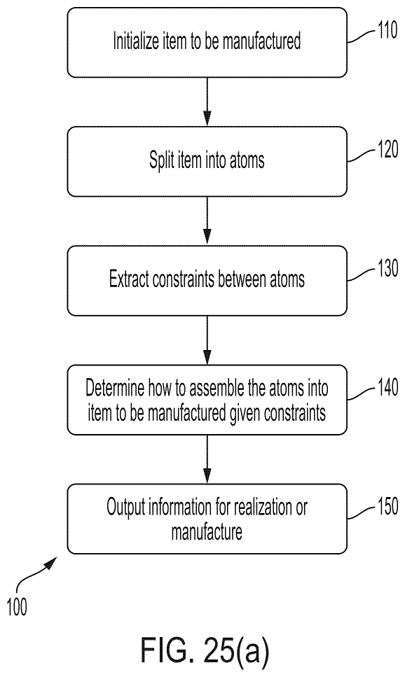

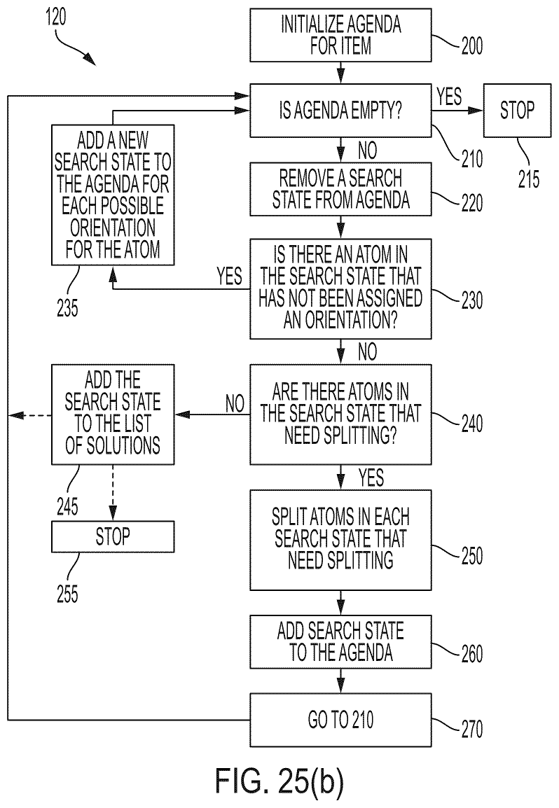

To illustrate, with reference to FIG. 25(a), according to the presently described embodiments, a flowchart for an example method 100 is shown. An item to be manufactured is initialized (at 110). Of course, those of skill in the art will understand that the item to be manufactured in this environment is represented in the system according to the presently described embodiments by a digital model, which could be a model for an end-product to be formed using two-dimensional or three-dimensional manufacturing techniques. The digital model may be generated in any appropriate manner suitable to achieve the objectives of the presently described embodiments.

Once initialized, the item is split into atoms (at 120). In at least one form, the technique of the presently described embodiments splits the item into atoms based on various properties such as the presence or absence of support, the need for scaffolding, tool reachability constraints, and the presence of cycles of dependencies which prevent the item from being manufactured.

In at least one embodiment, the atoms are split in an iterative manner. That is, the splitting of an atom depends on the atoms split beforehand—as opposed to splitting based on a single predetermined plan or splitting atoms on an overly granular basis searching for solutions for each individual atom split using techniques that merely amount to trial-and-error approaches. According to the presently described embodiments, in at least one form, the splitting is accomplished by maintaining selected knowledge of the constraints of the system so the splitting process can progress through stages or levels of splitting in an informed manner. In at least one example, the splitting is informed by corresponding searching such as searching to determine the most promising condition, e.g., orientation, for the atom to be split. In at least one form, determining the most promising orientation depends on at least understanding any necessary support (e.g., either native support or by adding scaffolding atoms) available to the atom and understanding the necessary accessibility for the system tools to form the atom.

As one example, with reference to FIG. 25(b), the atoms may be split as follows. This example demonstrates one of the various manners that iterative splitting of atoms may be implemented. An agenda of search states is initialized and maintained (at 200). Each search state keeps track of the set of atoms proposed so far, the set of atoms that have not been assigned an additive orientation, the additive orientation of the atoms that have been assigned, the set of scaffolding atoms that haven't been assigned a subtractive orientation, and the subtractive orientations of the scaffolding atoms that have been assigned. Starting the manufacture from nothing, then the agenda is initialized with a search state that has one atom—the item to be manufactured. This atom is put in the list of atoms that haven't been assigned an additive orientation.

If the agenda ever becomes empty (at 210), the process is stopped (at 215). Otherwise, the most promising search state is selected from the agenda (at 220) for processing, as below. For each atom in the search state that has not been assigned an additive orientation (at 230), an additive orientation is picked. If a greedy search is conducted, the most promising orientation is picked. Otherwise, we non-deterministically pick orientations, adding a new search state for each orientation (at 235). Similarly, a subtractive orientation is picked for each scaffolding atom that doesn't have one.

If all atoms in a search state have been assigned additive and subtractive orientations, then atoms that need splitting are located (at 240). The atoms are then split (at 250). For example, for each possible orientation, the non-scaffolding atoms are split that are partially supported and partially unsupported. The new atoms are added to the list of atoms that don't have an additive orientation assigned.

For each possible orientation, the process also creates and/or splits scaffolding atoms so that every non-scaffolding atom is supported and so that every scaffolding atom only supports one scaffolding atom directly. New scaffolding atoms are added to the list of atoms that don't have an additive orientation assigned and the list of atoms that don't have a subtractive orientation assigned.

The process also breaks cycles involving the atoms that have been assigned orientations by creating a graph of support and clearance dependencies between the atoms. A list of cycles to be broken is created by finding all paths of length one between any pair of atoms, then all paths of length two, then all paths of length three, etc. Whenever a path is found from an atom to itself, the path is added to the list of cycles. Paths from an atom to itself are ignored when building paths between all pairs of atoms.

To break a cycle, a link is chosen to break. If a greedy search is conducted, the most promising link is chosen. Otherwise, the process non-deterministically chooses each link, creating a new search state for that choice. The link is broken by splitting one of the atoms along one dimension between the two atoms. Which atom is split depends on the details of the link. Any new atoms are added to the list of atoms that don't have an orientation assigned.

Search states are then added to the agenda (at 260). The processing then starts again (at 270).

Referring back to 240, if a search state doesn't have any atoms that need an orientation assigned or need to be split, then the search state is added to the set of candidate solutions (at 245). At this point in the process, the routine may stop (at 255). Alternatively, the method continues on and returns to 210. It will be appreciated that, to find the best solution, all possible solutions may be pursued as the process continues. However, it should also be appreciated that finding all possible solutions, even if possible, may not be desired because it could consume too much time and/or resources. Thus, in at least one form, the decision to stop or continue is based, at least in part, on a preference or setting such as a user or design or predetermined preference on the number of solutions desired for a given implementation. For example, the first solution may be accepted where investigating all possible solutions is excessively time-consuming. As alternatives, any number of solutions could be set as the preference or setting. In this regard, the preference or setting may be to consider the first ten (10) solutions. As a further example, the preference or setting may be to consider the first (or more than one) solution that has a particular property. Other factors for determining criteria for the preference or setting could also be used.

Referring back to FIG. 25(a), after splitting, constraints between the atoms are then extracted (at 130). In this regard, for example, to test a candidate solution, support, clearance, and connectedness constraints are extracted and used to create a planning problem for the planner.

Next, it is determined how to assemble the atoms into the item to be manufactured given the constraints (at 140). In this regard, for example, a planner determines whether there is an ordering of additive and subtractive actions that satisfies the constraints, where the possible additive and subtractive actions are determined by the orientations chosen for each atom in the candidate solution.

Last, suitable information is output by the system for realization or manufacturing purposes (at 150). Various output techniques may be implemented to provide information to a realization and/or manufacturing system. The realization or manufacturing system may take any form suitable for a particular application. For example, the system may take the form of a three-dimensional printer or another system capable of additive, subtractive, or hybrid manufacturing. The item is then manufactured according to the information output according to the presently described embodiments. In some forms, the system may, as an alternative or supplemental feature, comprise a system for generating a simulation of an end-product.

It should also be appreciated that tool constraints are a factor in the implementation of the presently described embodiments. That is, to automate the hybrid manufacture of an item of manufacture according to at least one form of the presently described embodiments, e.g., according to the method 100, the system needs to have access to or learn about the tools that can be used in the process, such as the orientations that the item of manufacture can be in relative to the additive and subtractive tools, how much clearance the tools need beyond line-of-sight access to the atom being added or subtracted, and how much overhang the additive tool allows.

Also, for explanation purposes, it is assumed that the only orientations allowed are the cardinal orientations, that only strict clearance (no extra clearance needed for the tools) is needed, and that only strict support (no overhang allowed) is allowed. These assumptions may be relaxed in appropriate circumstances later in this description.

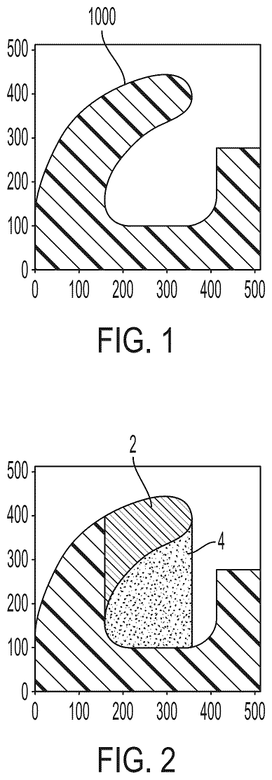

To further explain the presently described embodiments, including the example method 100 of FIG. 25, reference is now made to FIG. 1 through FIG. 24(d). Tool constraints, extraction of planning constraints between atoms, cycles of dependency between atoms and several other considerations will also be addressed in greater detail below.

In this regard, to manufacture a two-dimensional (2D) item such as the item 1000 shown in FIG. 1, in one form, the only orientations allowed are vertical (from the top) and horizontal (from the right). The item 1000 to be manufactured, according to the presently described embodiments, will be split into atoms based on their support (or lack of support). Scaffolding atoms will be added to support the atoms that do not have any other support.

FIG. 2 shows the item 1000 to be manufactured split into two atoms based on vertical support. The atom 2 doesn't have any support, so it is split off from the rest of the item to be manufactured. An atom 4 is inserted under it to provide support. By convention, stippling is used in the drawings for scaffolding atoms (such as atom 4) and cross-hatching is used for non-scaffolding atoms (such as atom 2).

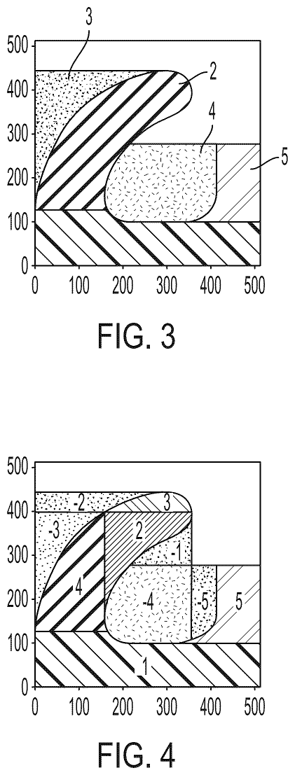

FIG. 3 shows the item 1000 to be manufactured split into three atoms based on horizontal support. The two cross-hatched atoms 2 and 5 are unsupported horizontally, so they are split off from the rest of the item to be manufactured. The two stippled atoms 3 and 4 provide scaffolding for the two unsupported, cross-hatched atoms 2 and 5.

FIG. 4 shows what happens when the process splits vertically first, and then splits horizontally on the resulting atoms. Negative numbers are used for scaffolding (stippled) atoms and positive numbers are used for non-scaffolding (cross-hatched) atoms. Some of the atoms (like atom 4 and atom −4) are just the intersection of the atoms from FIG. 2 and FIG. 3. But atom 3 is split off from atom 2 because it is unsupported horizontally, whereas atom 2 is supported horizontally by atom 4. If atom 4 wasn't there, then atom 3 would not have been split off from atom 2. Atom −3 is split off from atom −2 because the two scaffolding atoms support different atoms. In the presently described embodiments, in at least one form, each scaffolding atom only supports one real, or non-scaffolding, atom to allow the real atoms to be supported independently in case scaffolding is not needed for all of the real atoms.

Including atom 3 in FIG. 4 seems to allow the manufacture of this item without any scaffolding by doing the following:
1. add atoms 1, 4, and 5 vertically
2. rotate the item 90 degrees counterclockwise
3. add atom 2 vertically
4. rotate the item 90 degrees clockwise
5. add atom 3 vertically

In this regard, it will be appreciated that the presently described embodiments may be implemented in the case of pure additive manufacturing where the item of manufacture can be manufactured layer by layer using multiple orientations. This allows for manufacturing some items that can be manufactured using more than one orientation.

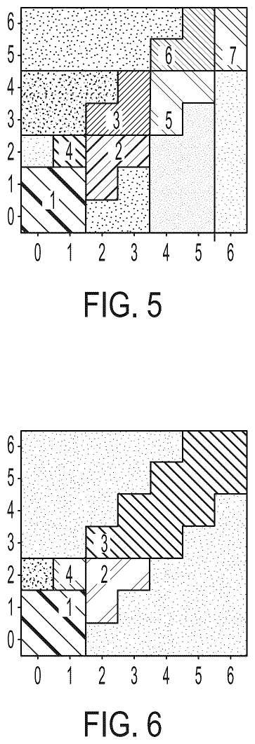

FIG. 5 shows that it may be necessary to iteratively split atoms in each orientation to get the desired atoms. If stopped after splitting in each orientation once, then the result would be FIG. 6. Note that it is not possible to manufacture FIG. 6 without scaffolding, whereas it is possible to manufacture FIG. 5 without scaffolding. In this regard, as described in the example scenarios above, according to the presently described embodiments, in at least one form, the splitting is accomplished by maintaining selected knowledge of the constraints of the system so the splitting process can progress through stages or levels of splitting in an informed manner. In at least one example, the splitting is informed by corresponding searching such as searching to determine the most promising condition, e.g., orientation, for the atom to be split. In at least one form, determining the most promising orientation depends on at least understanding any necessary support (e.g., either native support or by adding scaffolding atoms) available to the atom and understanding the necessary accessibility for the system tools to form the atom.

As alluded to above, to add or subtract atoms, the appropriate tool needs to be able to access the atom. The clearance is determined for each atom in each orientation by scanning upward from an atom and recording all of the atoms that are encountered. As long as those atoms do not exist when the atom is added or subtracted, then the tool will be able to do its job. This is not always sufficient, though, since it may be that for various reasons the atom depends on the existence of one of its clearance atoms in order to be added or subtracted. This case is addressed in the section on cycles below.

To compute a property of the atoms like support, scaffolding, or clearance, the voxels are scanned from bottom to top one plane at a time. For scaffolding, the scan is top to bottom. For each plane, a comparison is made with the previous plane to see where there has been a change of atoms. For each voxel where there has been a change of atoms, a new property is computed for the voxel based on the property of the voxel below it and other local information. For each voxel where there has not been a change of atoms, the property of the voxel below it is carried over, unchanged.

For instance, to split non-scaffolding atoms based on their support or lack thereof, the property of voxels whose atoms have changed is set since the previous layer to be True if the new atom and the atom below it are both non-scaffolding atoms, and False otherwise.

When determining the properties of the voxels is complete, each atom that has more than one property value in it is split into multiple atoms, one for each property value. Then it is checked whether any of the resulting atoms are discontinuous. Each discontinuous atom is split into multiple atoms so that all atoms are continuous.

Once an item of manufacture is split into the appropriate atoms, constraints are extracted that would allow a standard planner to determine the optimal plan for assembling the atoms into the desired item. The optimal plan will depend on the cost of scaffolding and the cost of changing the orientation of the currently assembled atoms.

To start with a blank slate and build up from nothing, then the initial state will assert that none of the atoms exist. To start with a block of material and subtract material to get to the item of manufacture, then the initial state will assert that all atoms needed to make up the block of material exist.

The final state asserts that all atoms in the item of manufacture exist, and no scaffolding atoms exist.

For each atom and orientation, an action is created that adds that atom in the given orientation. In the precondition of the action, the atom doesn't already exist, the partial assembly is in the correct orientation, and the additive tool is enabled. In the consequent of the action, the atom exists and the cost of performing the action is added to the overall cost. The precondition should also assert the existence of any atoms that are needed to support the atom while it is being added, and also assert the non-existence of any atoms that are in the clearance of the atom (so that the tool has access to the atom).

It may not be possible to rotate a partial assembly if the assembly is not fully connected. For instance, it isn't possible to build an arch by building the columns additively first, then rotating the columns 90 degrees, and then building the arch additively. When you rotated the columns, they would collapse together unless there is some means of holding them in place relative to each other. To solve this problem, we add preconditions to each additive action to the effect that one of the neighboring atoms must already exist. This is only needed for actions that don't need support, since the support requirement already guarantees connectivity. We do this for all of the additive actions that don't need support except for one action. This action will be the first atom added if we are starting from a blank slate.

For each scaffolding atom and subtractive orientation, an action is created that subtracts the action along the given orientation. In the precondition of the action, the atom already exists, the partial assembly is in the correct orientation, and the subtractive tool is enabled. In the consequent of the action, the atom does not exist and the cost of performing the action is added to the overall cost. The precondition should also assert the non-existence of any atoms that are in the clearance of the atom.

An action is created for each tool that enables the tool and disables all other tools. The action also adds the cost of performing the action to the overall cost.

An action is created for each orientation that sets the orientation of the partial assembly relative to the current tool. The action also adds the cost of performing the action to the overall cost. If the planner allows it, a precondition is added that the partial assembly is fully connected. This is needed because subtractive actions can make a fully connected assembly be disconnected.

If a plan for FIG. 4 is created and given to the planner, it is not possible to build it. This is because there is a cycle of dependencies within the atoms. As shown, atom 5 extends under atom −5 as well as atom −4.

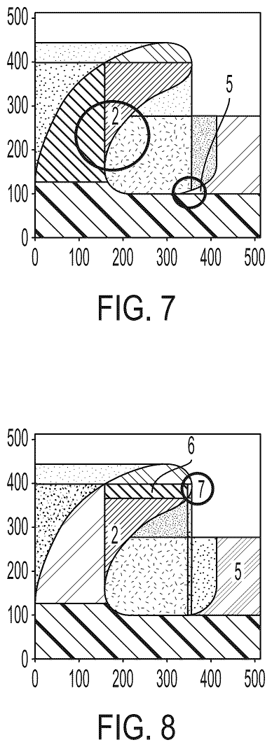

FIG. 7 shows that there is a cycle of dependencies between atom 2 and atom 5. Atom 5 is in the horizontal clearance of the circled part of atom 2, and atom 2 is in the vertical clearance of the circled part of atom 5 (a few pixels in the center of the circle).

FIG. 8 shows one way that the cycle of dependencies can be broken. If atom 2 has a small part of it split off into atom 7, then atom 2 is no longer in the vertical clearance of atom 5. Splitting atom 7 off causes other atoms to be created, such as atom 6. (Atom 6 is created because it is supported vertically by atom 2, whereas atom 7 is vertically unsupported.)

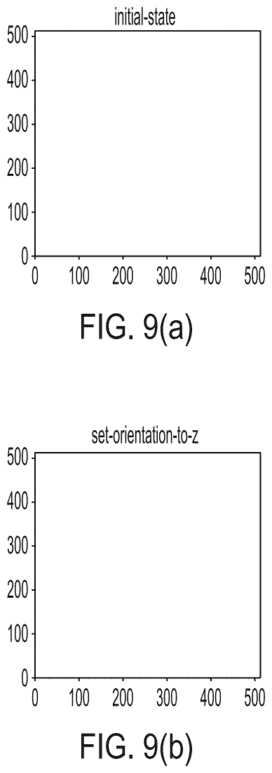

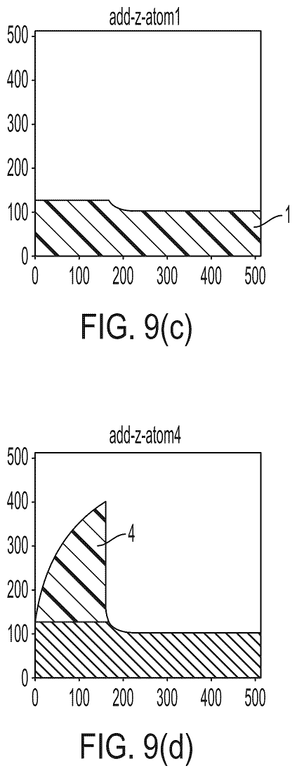

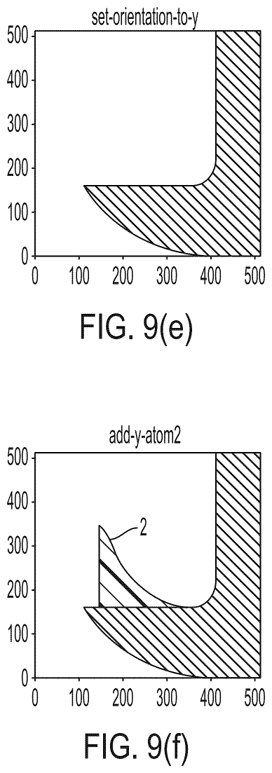

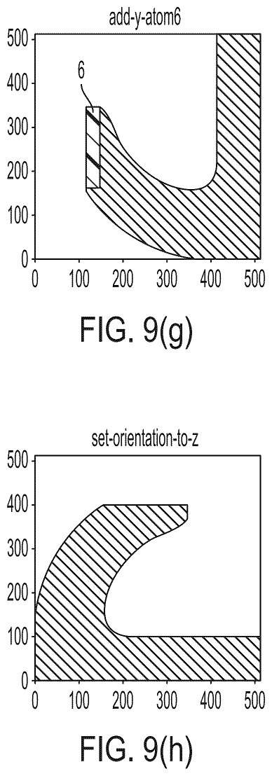

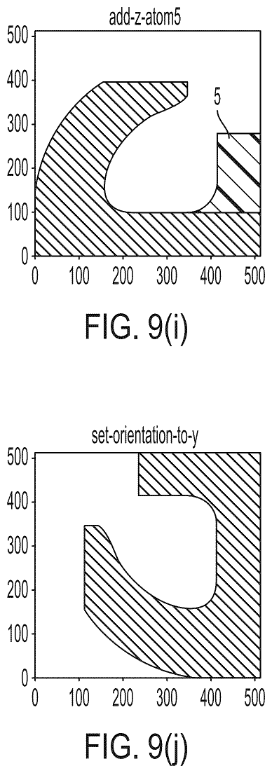

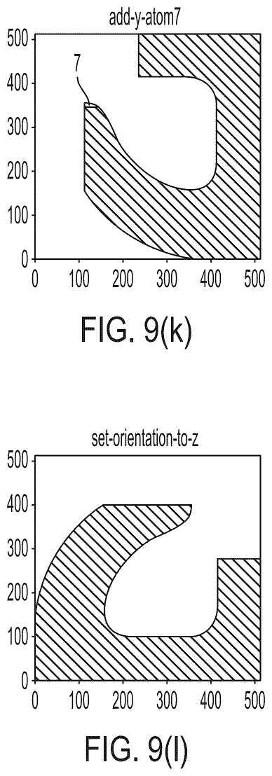

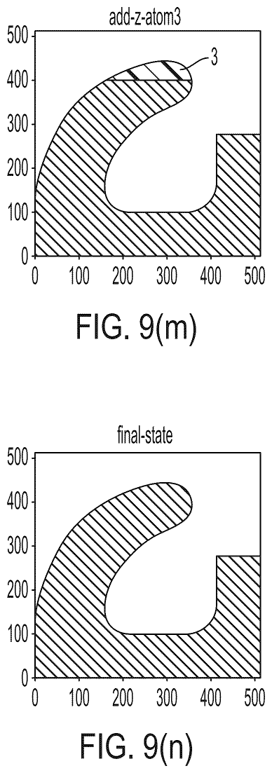

Once the dependency cycle is split, the planner can find a plan. With reference to FIGS. 9(a)-9(n), an example plan includes establishing an initial state (FIG. 9(a)). Next, an orientation is set to z (FIG. 9(b)), and atom 1 is added (FIG. 9(c)) as well as atom 4 (FIG. 9(d)). The orientation is set to y (FIG. 9(e)) before atom 2 (FIG. 9(f)) and atom 6 (FIG. 9(g)) are added. The orientation is set again to z (FIG. 9(h)). Atom 5 is then added (FIG. 9(i)). The orientation is returned to y (FIG. 9(j)) and atom 7 is added (FIG. 9(k)). Note that if atom 7 had been added earlier, then atom 5 could not have been added. The orientation is then set to z (FIG. 9(I)) to add atom 3 (FIG. 9(m)) to achieve a final state (FIG. 9(n)).

In general, cycles are not much of a problem in 2D, but they become a problem in 3D. This is because cycles usually get broken when atoms are split in 2D, but not in 3D.

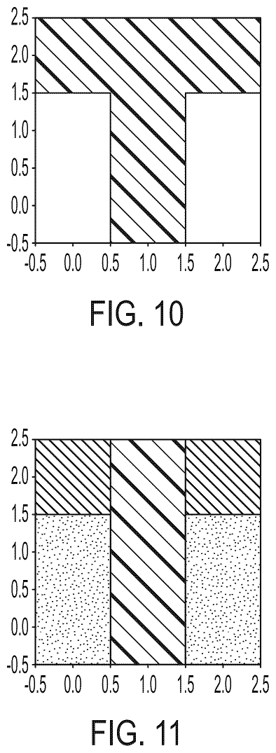

For instance, FIG. 11 shows how a column supporting a platform (FIG. 10) would be atomized in 2D. The middle of the platform is supported, so it is split off from the left and right parts, which are unsupported. Since the left and right parts are discontinuous, they become separate atoms.

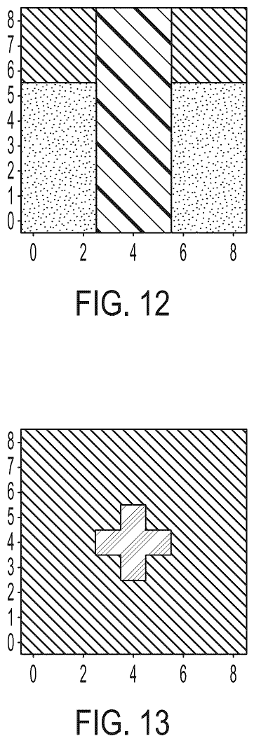

In the 3D case, the column does not necessarily split the platform in two (FIG. 12). That is because the platform can go around the column when viewed from above (FIG. 13). This leads to a cycle horizontally since atoms by their nature are added atomically and cannot be interleaved. So, the platform cannot be built first, since part of it is supported by the column, and the column cannot be built first since it is in the clearance of part of the platform.

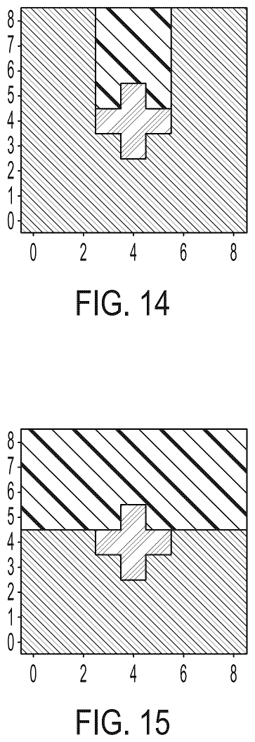

There are two major ways to break the cycle in FIG. 13. An atom can be split off from the platform in the clearance of the column (FIG. 14), or an atom can be split off from the platform horizontally at the lowest point above the column (FIG. 15).

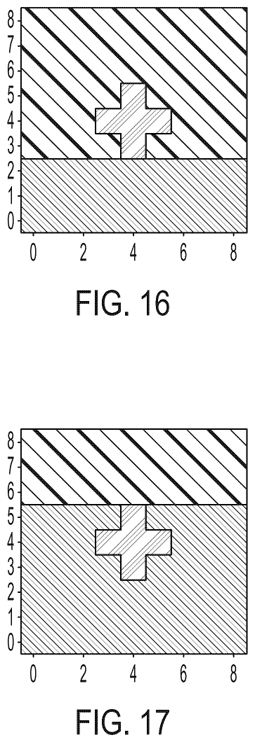

FIG. 16 and FIG. 17 show that horizontal splits do not always eliminate the cycle. In FIG. 16, the new atom is still in a cycle with the column, because the new atom is supported by the column and the column is in the clearance of part of the new atom. This is similarly shown in FIG. 17.

In general, it is found that breaking a cycle vertically (FIG. 14) can produce more cycles since the clearance acts like a column, whereas breaking a cycle horizontally (FIG. 15) tends to not produce more cycles since the break is planar. So, breaking cycles horizontally is accomplished when possible. If a cycle has more than one link in it, then only one link is needed to break the cycle. One approach is to break a link that looks like FIG. 15 where possible, and otherwise to break the link between the two atoms horizontally at the lowest point between them.

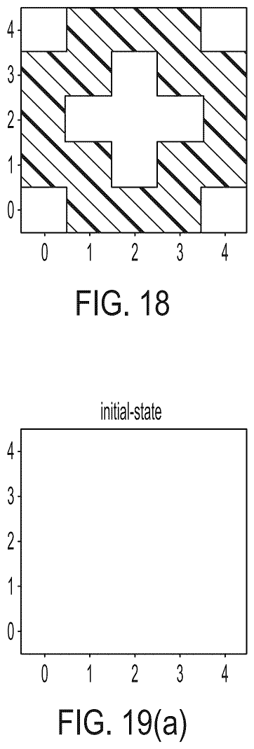

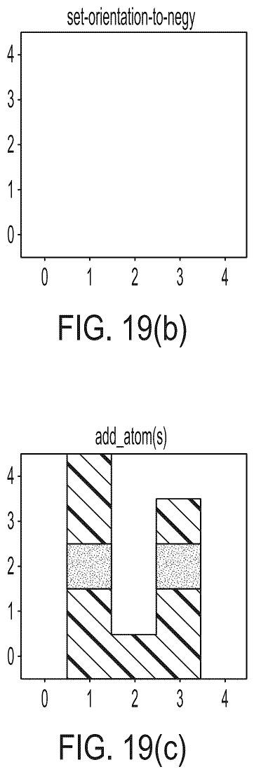

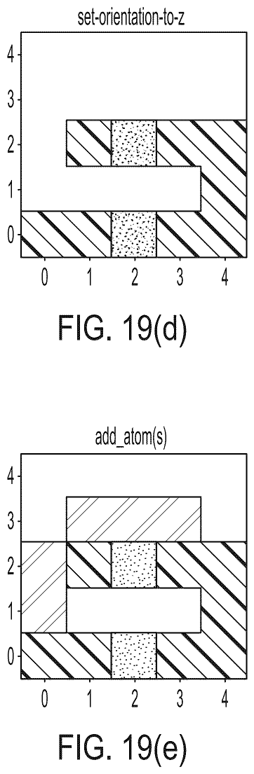

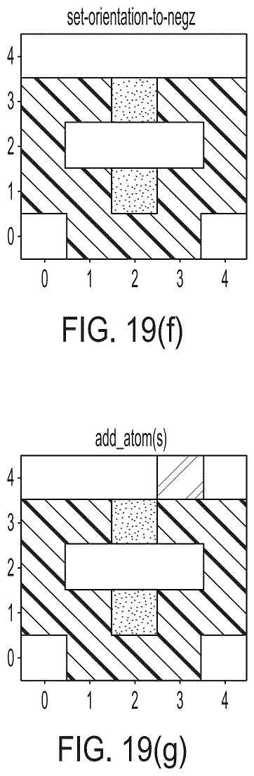

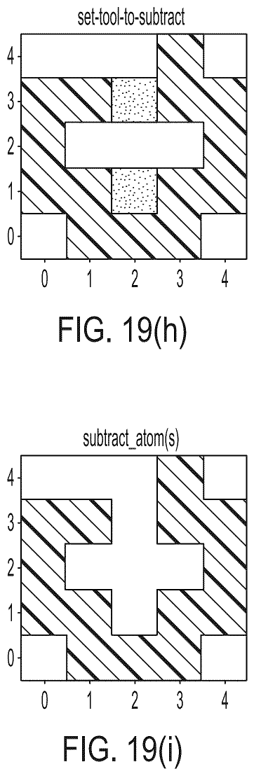

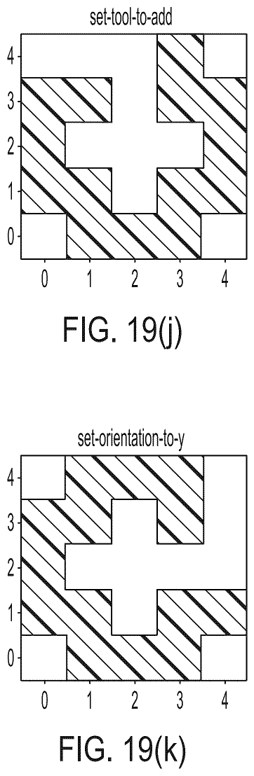

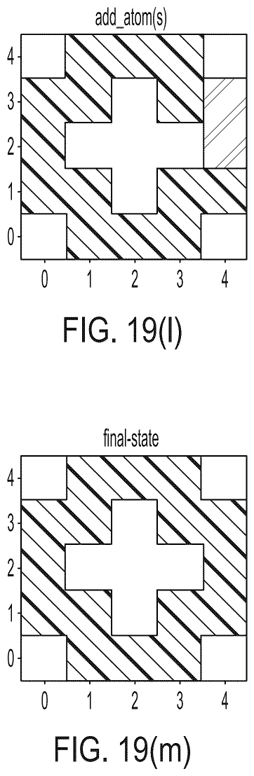

FIG. 18 shows another example of an element that may be useful to manufacture. FIGS. 19(a)-(m) show the plan according to which the two-dimensional element of FIG. 18 can be manufactured using both additive and subtractive actions. (The stippled parts are the scaffolding that will need to be removed.)

With reference to FIG. 19(a) through FIG. 19(m), an example assembly plan begins with an initialization of the process (FIG. 19(a)). Next, the orientation is set to −y (FIG. 19(b)) and the illustrated atoms are added (FIG. 19(c)). The orientation is then set to z (FIG. 19(d)) before more atoms are added (FIG. 19(e)). As the plan progresses, the orientation is changed again, this time to orientation −z (FIG. 19 (f)), and the illustrated atom is added (FIG. 19(g)). Next, the tools are set to subtract (FIG. 19(h)) and the appropriate atoms are subtracted (FIG. 19(i)). The tools are reset to add (FIG. 19(j)) and the orientation is set to y (FIG. 19(k)) before the final atoms are added (FIG. 19(I)) to achieve the final state (FIG. 19(m)).

So far, atoms have been strictly supported vertically, and no overhang is allowed. To extend the algorithm to allow for some overhang, criterion is extended to include atoms that are below and offset by a prespecified amount that is determined by the angle of support allowed.

So far, only simple examples have been considered with a few orientations in two dimensions (2D). This has let us consider all possible orientations for each atom when we are atomizing the item of manufacture. When more orientations are added or switched to three dimensions (3D), the number of possible atoms can grow very large.

Changing the atomizer to choose an orientation for each atom simplifies the approach. This way, the only concern is about support and clearance in one orientation rather than in all orientations. Also, it reduces the number of cycles that are addressed. After atomization the planner is only used to choose the best ordering of the actions given the chosen orientations and to verify that the partial assembly remains connected.

The downside of this approach is that all possible orientations in the atomizer are enumerated for the best possible plan. But with carefully chosen orientations, it is likely to get at least some plan out of the planner the first time. If necessary, backtracking can be done until we get a set of orientations that allows the item to be manufactured.

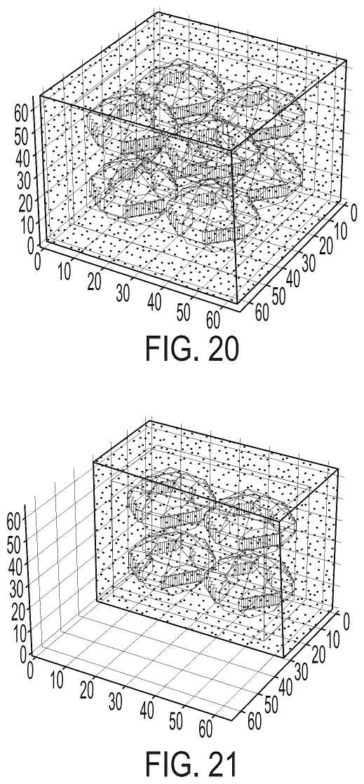

For a realistic 3D item to manufacture, FIG. 20 is a box with solid walls and an internal structure that provides compression support. The Figure is translucent to expose part of the internal structure. FIG. 21 shows a cross-section of the box to make the internal structure more visible. The internal structure is designed to make it easy to manufacture if the additive tool allows an angle of support of 45 degrees. The walls would be easy to manufacture except that the entire structure is enclosed.

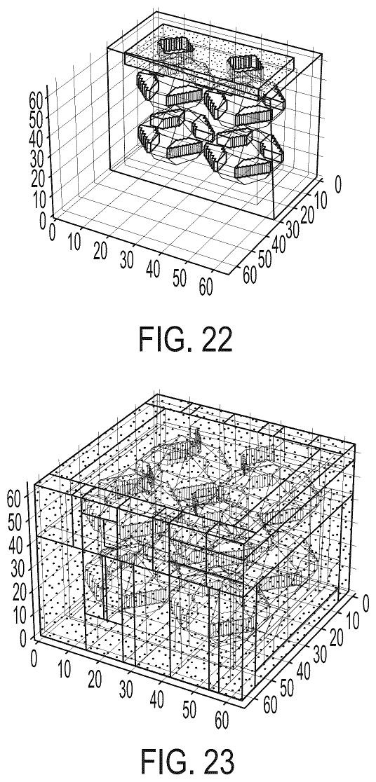

FIG. 22 shows a cross-section of the atomization after the box has been split into atoms based on vertical support. All of the parts are supported vertically except for the internal support structures that are completely horizontal and part of the top. All of these parts are supported horizontally (e.g., if we were to rotate the assembly 90 degrees so that the top was on the side, then they would be supported). This means that only 34 atoms are needed if cycles are ignored. But since the unsupported parts are surrounded by a single atom that represents the remainder of the box, it is not possible to manufacture the box using these atoms.

FIG. 23 shows the atomization of the box once all cycles have been eliminated algorithmically. There are 181 atoms.

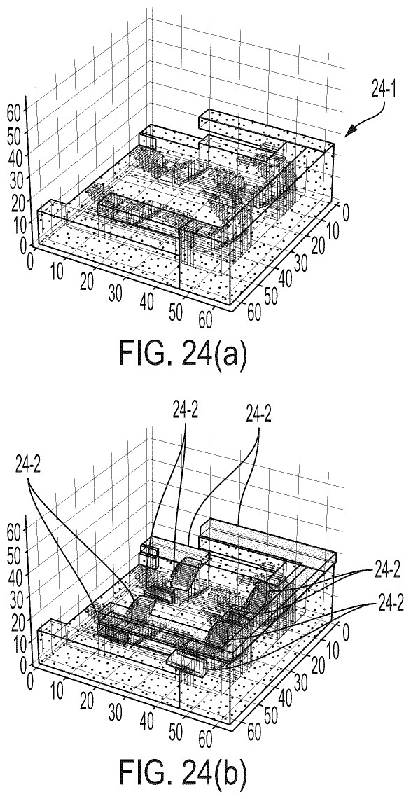

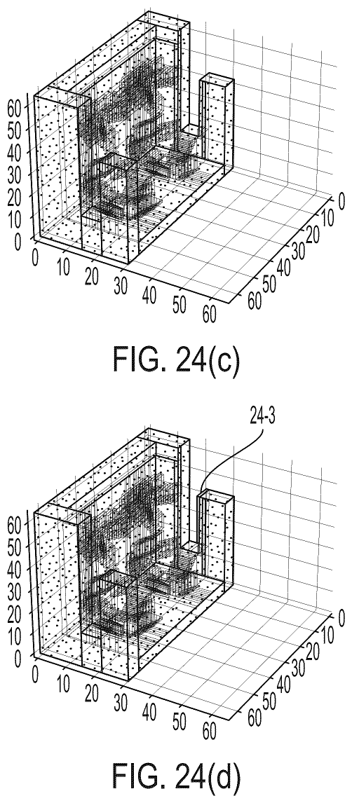

FIG. 24(a) through FIG. 24(d) illustrates parts of a three-dimensional assembly plan and shows the box being assembled. It will be appreciated that a review of these figures reveals that operations (e.g., initializing, adding atoms, subtracting atoms, changing the orientation, . . . etc.) like the operations described in connection with FIGS. 9(a)-(n) and FIGS. 19(a)-(m) are implemented to achieve an appropriate assembly plan to manufacture the desired part.

With reference to FIGS. 24(a)-(d), it is clear that at various points in the process, it should be recognized that an atom or plurality of atoms, such as group of atoms 24-1, is placed in an orientation (FIG. 24(a)) and atoms are added (FIG. 24(b)) such as atoms 24-2. The orientation of the structure is then changed (FIG. 24(c)) and more atoms are added (FIG. 24(d)) such as atoms 24-3. The illustrations are only selected examples of the process to achieve a structure of FIG. 20 using the split atoms of FIG. 23. The remaining parts of the process (not shown) are accomplished in a similar fashion to initialize or orient, add atoms, change orientation, add atoms, . . . etc. Each item to be manufactured will have a unique process to accomplish the objective of the presently described embodiments.

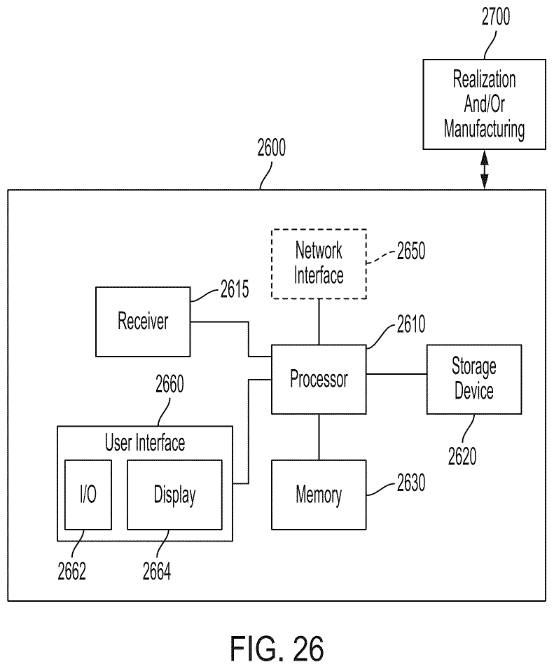

With reference now to FIG. 26, the above-described methods can be implemented on a computer using well-known computer processors, memory units, storage devices, computer software, and other components. A high-level block diagram of such a computer is illustrated in FIG. 26. Computer 2600 contains at least one processor 2610, which controls the overall operation of the computer 2600 by executing computer program instructions which define such operation. The computer program instructions may be stored in at least one storage device or memory 2620 (e.g., a magnetic disk or any other suitable non-transitory computer readable medium or memory device) and loaded into another memory 2630 (e.g., a magnetic disk or any other suitable non-transitory computer readable medium or memory device), or another segment of memory 2620, when execution of the computer program instructions is desired. Thus, the steps of the methods described herein (such as method 100 of FIG. 25) may be defined by the computer program instructions stored in the memory 2630 and controlled by the processor 2610 executing the computer program instructions. The computer 2600 may include one or more network interfaces 2650 for communicating with other devices via a network. The computer 2600 also includes a user interface 2660 that enables user interaction with the computer 2600. The user interface 2660 may include I/O devices 2662 (e.g., keyboard, mouse, speakers, buttons, etc.) to allow the user to interact with the computer. Such input/output devices 2662 may be used in conjunction with a set of computer programs as an annotation tool to annotate images in accordance with embodiments described herein. The user interface also includes a display 2664 for displaying images and spatial realism maps to the user.

According to various embodiments, FIG. 26 is a high-level representation of possible components of a computer for illustrative purposes and the computer may contain other components. Also, the computer 2600 is illustrated as a single device or system. However, the computer 2600 may be implemented as more than one device or system and, in some forms, may be a distributed system with components or functions suitably distributed in, for example, a network or in various locations.

It will be appreciated that at least one form of the presently described embodiments will include a realization and/or manufacturing system 2700. The realization or manufacturing system 2700 may take any form suitable for a particular application. For example, the system 2700 may take the form of a three-dimensional printer or another system capable of additive, subtractive, or hybrid manufacturing. In some forms, the system 2700 may comprise a system for generating a simulation of an end product. Again, various output techniques may be realized for the realization and/or manufacturing system 2700.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to facilitate embodiments described above.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for automated manufacturing comprising:
selecting a digital model for an item to be manufactured;
iteratively splitting the model into atoms including selectively assigning for each atom at least one of an additive orientation and a substractive orientation;
extracting constraints between the atoms;
determining how to assemble the atoms into the item to be manufactured based on the constraints; and,
outputting information configured for realization or manufacturing of the item.

2. The method as set forth in claim 1, wherein the splitting is based on at least one of a presence or absence of support, a need for scaffolding, tool constraints, and a presence of cycles of dependencies.

3. The method as set forth in claim 1, wherein the splitting comprises initializing an agenda for the item.

4. The method as set forth in claim 3, wherein the agenda comprises search states and the splitting further comprises removing a search state from the agenda and processing the search state.

5. The method as set forth in claim 4, wherein the processing creates new search states added to the agenda.

6. The method as set forth in claim 3, wherein the splitting is completed when the agenda is empty.

7. The method as set forth in claim 1, wherein the splitting is informed by searching to determine a condition.

8. The method as set forth in claim 7, wherein the condition is orientation.

9. The method as set forth in claim 1, wherein the extracting comprises extracting at least one of support, clearance and connectedness constraints.

10. The method as set forth in claim 1, wherein the determining comprises determining whether there is an order of additive and subtractive actions that satisfies the constraints.

11. The method as set forth in claim 1, wherein the outputting comprises outputting to at least one of a three-dimensional printer or a system configured for additive, subtractive, or hybrid manufacturing.

12. A system for automated manufacturing comprising:
at least on processor; and,
at least one memory having instructions stored thereon wherein execution of the instructions by the processor causes the system to:
select a digital model for an item to be manufactured including selectively assigning for each atom at least one of an additive orientation and a subtractive orientation;
iteratively split the model into atoms;
extract constraints between the atoms;
determine how to assemble the atoms into the item to be manufactured based on the constraints; and,
output information configured for realization or manufacturing of the item.

13. The system as set forth in claim 8, wherein the model is split is based on at least one of a presence or absence of support, a need for scaffolding, tool constraints, and a presence of cycles of dependencies.

14. The system as set forth in claim 12, wherein the splitting comprises initializing an agenda for the item.

15. The system as set forth in claim 14, wherein the agenda comprises search states and the splitting further comprises removing a search state from the agenda and processing the search state.

16. The system as set forth in claim 15, wherein the processing creates new search states added to the agenda.

17. The system as set forth in claim 14, wherein the splitting is completed when the agenda is empty.

18. The system as set forth in claim 12, wherein the splitting is informed by searching to determine a condition.

19. The system as set forth in claim 18, wherein the condition is orientation.

20. The system as set forth in claim 12, wherein the constraints comprise at least one of support, clearance and connectedness constraints.

21. The system as set forth in claim 12, wherein the system determines whether there is an order of additive and subtractive actions that satisfies the constraints.

22. The system as set forth in claim 12, wherein the output information is sent to at least one of a three-dimensional printer or a system configured for additive, subtractive, or hybrid manufacturing.
